(19) United States
(12) Patent Application Publication
(10) Pub. No.: US 2003/0053154 A1
(43) Pub. Date: Mar. 20, 2003

(54) Image checking system

(76) Inventor: Yoshikatsu Kamisuwa, Kawasaki-shi (JP)

Correspondence Address: FOLEY AND LARDNER, SUITE 500, 3000 K STREET NW, WASHINGTON, DC, 20007, US

(21) Appl. No.: 09/955,292

(22) Filed: Sep. 19, 2001

(51) Int. Cl. H04N 1/46

(52) U.S. Cl. 358/504; 358/505

(57) ABSTRACT

A reference chart including a plurality of patterns for sampling each of characteristic quantities indicating characteristics of a defective image is read by an image scanner targeted for checking, and image data is stored in a memory. An image analyzing section samples the characteristic quantity of each of the plurality of patterns expressed in the image data. Sampling of the characteristic quantities is hardly affected by a displacement between ideal image data and the above stored image data. A correlation table holding section holds a correlation table which associates each phenomenon name for classifying defective image and at lest one of the characteristics quantities corresponding to the phenomenon name. Referring to the correlation table, a phenomenon name specifying section specifies a phenomenon name of a pattern region in which the characteristic quantity is sampled by the characteristic quantity sampling section from among the plurality of patterns expressed in the image data.

### BACKGROUND OF THE INVENTION

The present invention relates to an image checking system for checking a quality of image data read by a scanner, an image printed by a printer, or an image copied by a copying machine, and then, judging a state of the scanner, printer or copying machine from the check result.

In general, the quality of an image formed by a copying machine or the like is judged by subjective check based on a comparison between the image and a defective image sample. Namely, in a field in which equipment such as a copying machine is practically used or in line check during equipment manufacture, a service man compares the image with a defect limit sample, for example, shown in a manual, thereby subjectively evaluating a defective image.

In the above described field, when defective image is produced, the service man make checks as to what phenomenon occurs in the image by correlating it with a plurality of defective image samples presented in the manual. Thus, the check time or check precision greatly depend on the skillfulness of the service man. Namely, an unevenness occurs in a time required for checking, and judgment as to whether the image is defective or normal becomes subjective. Also, if it is not identified where the service man should make primary checks in a defective image sample, such defect cannot be found or amended at an earlier stage.

Further, when a user makes a phone call to a service center during a failure, in general, the user does not have special knowledge of a copying machine. Thus, expressions of defectives are various, thus making it difficult to grasp what is the real cause of such defect from the telephone conversation.

Such an automatic checking technique for a defective image is disclosed in Jpn. Pat. Appln. KOKAI Publication No. 11-109807, for example, wherein checks based on a difference from reference data are made. That is, according to this document, a read image information (electronic data) obtained by reading a test pattern image by a scanner unit is compared with recording image information (electronic data) used for printing the test pattern image. If these images are detected to be inconsistent, they are judged to be defective, and recording conditions for recording paper are reset.

In general, in such a method, a fine shift at a printout position, a skew, a distortion, or a change in multiplication occurs in an outputted image sample, making it impossible to adjust the positions of images to be compared between read image information and recording image information at a level of one pixel. Thus, even if it is detected that these images are inconsistent from each other at a character region for example, it is impossible to judge whether such inconsistency is caused by missing or by displacement in character regions which have been compared, by merely sampling differential data on these images. Thus, it is very difficult to precisely judge inconsistency, and such judgment is infeasible.

On the other hand, another system for automatically making such image checks is disclosed in Jpn. Pat. Appln. KOKAI Publication No. 2000-132364. In this document, output image sample information is sent as image data to a control center, and the image is analyzed at the control center. However, a transfer rate of a current communication network is 64 Kbps in the case of an ISDN, for example. If image data is 210 MB, a time of 7 hours 20 seconds is required for transfer. Thus, image transfer is impossible at the transfer rate of the current communication network.

Further, a copying machine and an intensive management apparatus for detecting an equipment malfunction are disclosed in Jpn. Pat. Appln. KOKAI Publication No. 2000-81813. In this document, an equipment operation sound is sampled and analyzed. In the case of this document, an image itself is not analyzed, and thus, it is impossible to judge whether or not a problem actually appears on an image.

### SUMMARY OF THE INVENTION

The present invention has been made in order to solve the problem. An object according to one embodiment of the present invention is to provide an image checking system capable of automatically recognize a defective image, and specifying type of a phenomenon that occurs in an image. An object according to another embodiment of the present invention is to provide an image checking system capable of estimating where an equipment malfunction occurs from the phenomenon that occurs in such an image.

According to one embodiment of the present invention, a reference chart including a plurality of patterns for sampling each of the characteristic quantities indicating characteristics of a defective image is read by an image scanner targeted for checking, and image data is stored in a memory. The characteristic quantity sampling section samples the characteristic quantities of each of the plurality of patterns expressed in the image data. The type of defective image is determined on the basis of the characteristic quantities. The characteristic quantities are characteristics obtained by processing the image data. These quantities include “insufficient resolution” and “brightening”, for example. The “brightening” indicates an average density of the image is lower than that of ideal image by more than a threshold. Such characteristic quantities are hardly affected by a displacement between the ideal image and the above stored image data.

A correlation table associates each label for classifying defective image with at least one of the characteristic quantities corresponding to the label. By referring to the correlation table, a label specifying section specifies the label for a pattern region, in which the characteristic quantities are sampled by the characteristic quantity sampling section, of the plurality of patterns expressed in the read image data.

A factor estimating section narrows candidates of the causes of a defect from the phenomenon of the thus analyzed defective image and any other information. These phenomenon and the causes of a defect are displayed at a display section.

According to the present invention, image data is directly analyzed, thus making it possible to recognize a defect that occurs in an output image sample.

The above described check processing is executed by a personal computer hand held by a service man, a personal computer connected to a copying machine via network, or a network computer or the like connected to the copying machine via network in the same manner.

### BRIEF DESCRIPTION OF THE DRAWINGS

FIG. 1 is a block diagram depicting a configuration of an image analyzing device according to one embodiment of the present invention;

FIG. 2 shows an example of a reference chart;

FIG. 3 shows an example of a reference chart characteristic list;

FIGS. 4A to 4C each show an example of various patterns assigned to each mesh of the reference chart;

FIGS. 5A to 5C are flowcharts showing a defective image checking process;

FIG. 6 shows an example of a mesh characteristic quantity table;

FIG. 7 shows an example of a correlation table;

FIG. 8 shows an example of a chart instruction table;

FIG. 9 is a flow chart showing another checking process;

FIG. 10 is a sectional view showing an internal structure of a digital copying machine to which the present invention is applied;

FIG. 11 is a block diagram depicting a configuration of a control system of the digital copying machine to which the present invention is applied;

FIG. 12 is a flow chart showing an embodied operation applied to the copying machine of FIG. 11;

FIG. 13 is a block diagram schematically depicting a configuration of an image checking system according to the present invention;

FIG. 14 is a flow chart showing an embodied operation applied to the system of FIG. 13;

FIG. 15 is a block diagram schematically depicting another configuration of the image checking system according o the present invention;

FIG. 16 is a flow chart showing an embodied operation applied to the system of FIG. 15;

FIG. 17 is a flow chart showing another embodied operation applied to the system of FIG. 15; and

FIG. 18 is a flow chart showing still another embodied operation applied to the system of FIG. 15.

### DETAILED DESCRIPTION OF THE PREFERRED EMBODIMENTS

Prior to giving a specific description of embodiments, a description of terms will be given. The terms used in the specification are defined as follows.

Image sample: Image expressed on paper

Image data: Electronic data expressing an image

Image reading data: Image data of image sample obtained by reading the image sample by image reader device

Output image sample: Image expressed on paper by outputting (printing) image data by image forming device

Copy image sample: Image expressed on paper by copying image sample by image copying device (hereinafter, simply referred to “copying device”)

Reference chart: Image on paper on which a specific pattern is expressed for defective image checking

Reference data: Electronic data for the reference chart

Reference chart characteristic list: List of data describing pattern configuration (or disposition) of the reference chart and characteristics (or pattern numbers) of each pattern

Phenomenon name: Name, i.e., label for defective image specific to an image reader device, an image forming device, or a copying device

(Examples) “image blurring” “main scanning black stripe” or “avalanche image”

Image characteristic quantity (or simply characteristic quantity): quantity of characteristic that can be sampled by image processing, the characteristic quantity being judgment material or judgment element for phenomenon name

(Examples) “darkening” “brightening”, “subs-canning” “stripe” or “non-uniformity”

Correlation table: Table describing relationship between each set of image characteristic quantities and phenomenon name

Hereinafter, preferred embodiments of the present invention will be described with reference to the accompanying drawings.

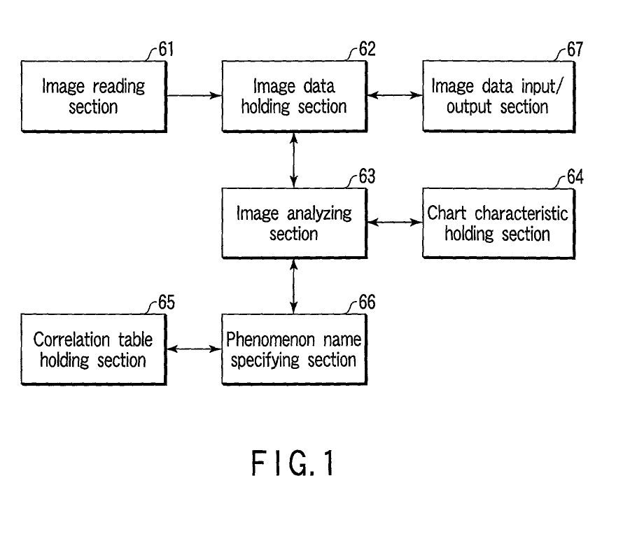

FIG. 1 is a block diagram depicting a configuration of an image analyzing device according to one embodiment of the present invention. This image analyzing device includes: an image reading section 61 that reads an image sample and produces electronic image data; an image data holding section 62 that holds the image data; an image analyzing section 63 that samples the image characteristic quantity; a chart characteristic holding section 64 that holds the reference chart characteristic list; a correlation holding section 65 that holds the correlation table for associating each set of image characteristic quantities and phenomenon name; a phenomenon name specifying section 66 for specifying the phenomenon name from the set of the image characteristic quantities and the correlation table; and an image data input/output section 67 for delivering image data between the image data holding section 62 and an external device. This image analyzing device, excluding the image reading section 61, can be used as an application that a service man can install in a personal computer or a copying machine.

Now, a variety of techniques for analyzing a defective image will be described.

First, a technique for checking a defective image caused by an image reader device will be described below. Reference data corresponding to a reference chart is inputted in advance from the image data input/output section 67 to the image data holding section 62. Also, a reference chart characteristic list is stored in advance in the chart characteristic holding section 64.

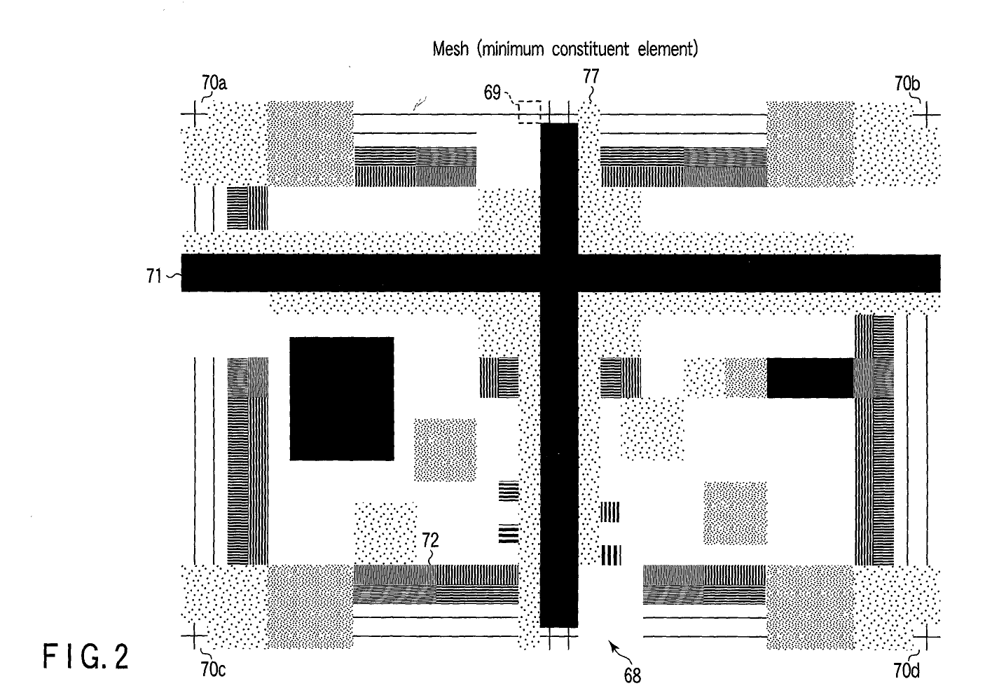

FIG. 2 shows an example of a reference chart. A reference chart 68 is finely divided into meshes each made of 50×50 pixels, for example, like a mesh 69. This chart is formed in a single pattern in each mesh.

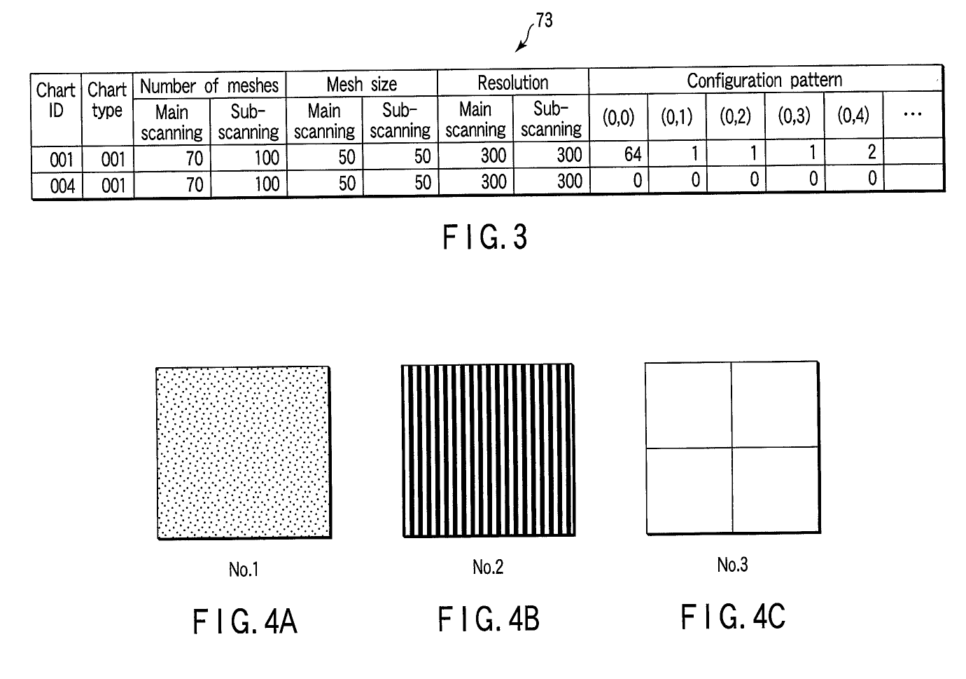

FIG. 3 shows an example of a reference chart characteristic list. A reference chart characteristic list 73 includes a chart ID that identifies a reference chart; a chart type that identifies type of reference chart; the number of meshes; mesh size; and pattern numbers indicating a type of pattern assigned to each mesh. With respect to these pattern numbers, as shown in FIGS. 4A to 4C, 1 is defined for a uniform pattern with density of 16, for example; 2 is defined for main scanning pair lines of a two-pixel cycle; and 3 is defined for a cross mark. These numbers are recorded corresponding to the coordinate of each mesh in the reference chart characteristic list 73. Each pattern is suitable to sample different characteristic quantities. For example, a pattern of No. 1 is suitable to sample “darkening” or “brightening”, for example. The darkening used here indicates that the average density of image data is higher than that of reference data by more than a threshold. The brightening used here indicates that the average density of image data is lower than that of reference data by more than a threshold. A pattern of No. 2 is suitable to sample an “insufficient resolution”.

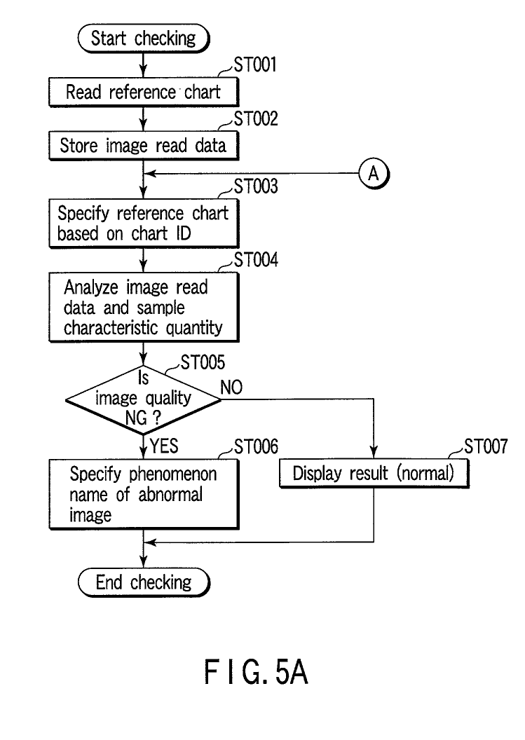

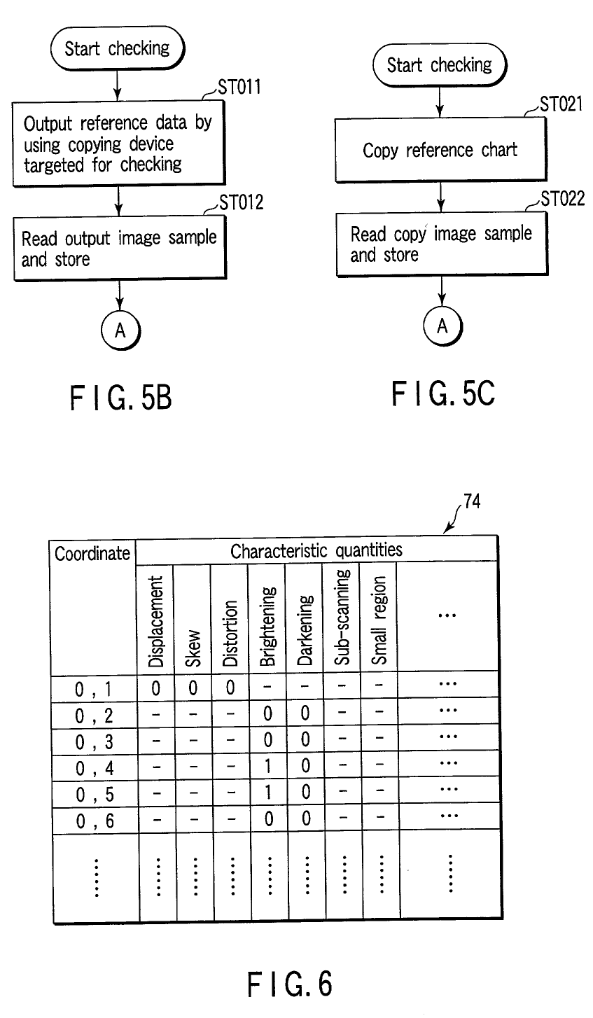

FIG. 5A is a flow chart showing a method for checking a defective image caused by an image reader device (scanner). First, the reference chart 68 is read by an image reader device targeted for checking, and the obtained image read data is stored in the image data holding section 62 through the image data input section 67 (steps ST001 and ST002).

The image analyzing section 63 samples an image characteristic quantity and creates a mesh characteristic quantity table by using the reference data and read image data stored in the image data storage section 62 and the reference chart characteristic list of FIG. 3 stored in the chart characteristic holding section 64. FIG. 6 shows an example of a mesh characteristic quantity table 74. In a mesh characteristic quantity table 74, truth/false of each characteristic quantity is recorded corresponding to the coordinate of each mesh.

For example, the image analyzing section 63 specifies the reference chart from a reference chart characteristic list 73 based on the chart ID described at a header section for reference data (step ST003). Then, as in meshes 70a to 70d (FIG. 2), the crossing point coordinates of crosses of cross mark meshes are detected based on reference data and read image data respectively, and differences of the crossing point coordinates between the reference data and read image data are detected. Then, characteristic quantities of displacement, skew, and distortion (or magnification shift) are computed from the detected differences. If there is a characteristic quantity which is equal to or larger than a threshold, corresponding characteristic quantity in the mesh characteristic quantity table 74 is set to “truth(“1”)”. When at least one of these characteristic quantities (displacement, skew, and distortion) is “truth”, the image analysis is terminated.

If all of the above characteristic quantities are smaller than thresholds, reference data and image data are roughly aligned each other according to the displacement quantity. Then the other characteristic quantities are sampled for each mesh, and the mesh characteristic quantity table 74 is continuously created (step ST004). For example, like a mesh 71 (FIG. 2), in a mesh with high density and a uniform pattern (plain black), the density values of reference data and image data in 40×40 pixels at the center of the mesh in which an effect of displacement can be ignored are compared. If a density difference between reference data and image data exceeds a threshold, the image analyzing section 63 judges that an image brightening occurs, and the characteristic quantity of “brightening” in the mesh characteristic quantity table 74 is set as truth (“1”). As in the mesh 72, in a pair line mesh, a density difference between a black stripe and a white stripe of image data is detected. If the difference is equal to or smaller than thresholds, the characteristic quantity of “insufficient resolution” is set as truth. Also, if the same characteristic quantity is sampled between continuous meshes in a subs-canning direction, the image analyzing section 63 sets the characteristic quantity of “sub-scanning” to truth.

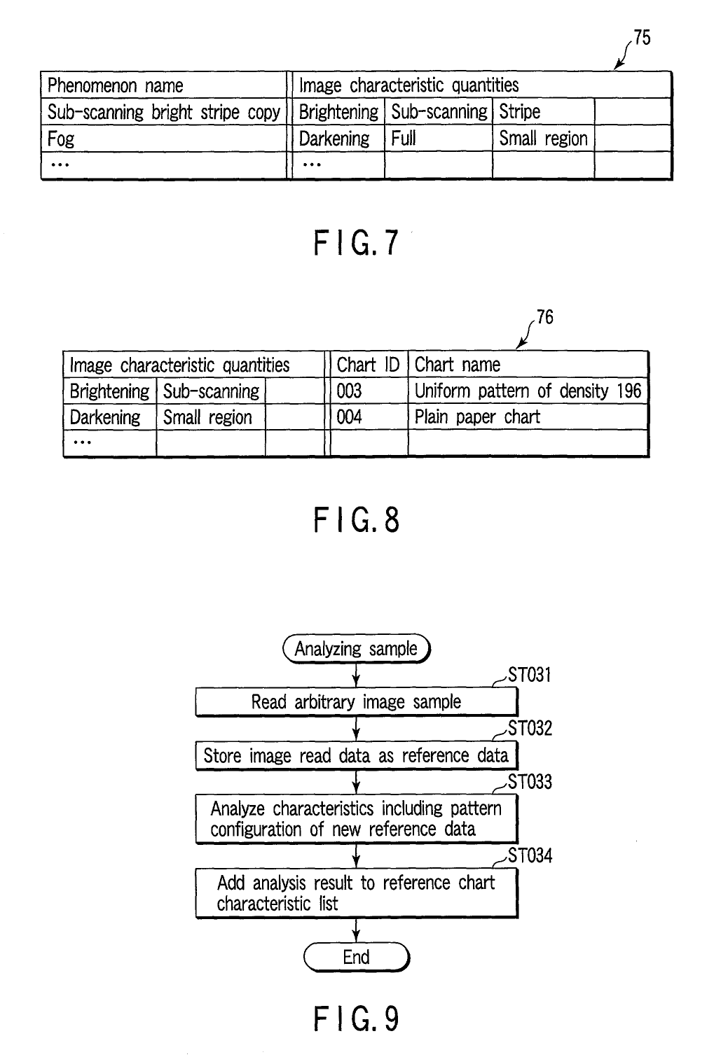

The phenomenon name specifying section 66 specifies a phenomenon name of a defective image from the thus obtained mesh characteristic quantity table 74 and the correlation table holding section 65 (ST006). FIG. 7 shows an example of a correlation table. A correlation table 75 specifies a correlation between a phenomenon name and an image characteristic quantities. For example, “brightening”, “sub-scanning”, and “stripe” are described as the corresponding image characteristic quantities in the field of a phenomenon name “sub-scanning bright stripe copy”. The phenomenon name specifying section 66 diagnoses, i.e., specifies the phenomenon name of the mesh region as “sub-scanning bright stripe copy” if all of these characteristic quantities are set to truth.

The phenomenon name “sub-scanning bright stripe copy” indicates that a stripe with its low density occurs in a sub-scanning direction. The “fog” indicates a defective image on which a plurality of small dots occur as a base of white like when newspaper is copied. The image characteristic quantity “subs-canning” indicates that a defective image occurs in the sub-scanning direction. The “small region” indicates a small dot.

Now, a technique for checking a defective image caused by an image forming device (printer) will be described. As described previously, the reference data corresponding to a reference chart is inputted in advance from the image data input/output section 67 to the image data holding section 62. Also the reference chart characteristic list 73 is stored in advance in the chart characteristic holding section 64.

FIG. 5B is a flow chart showing a method for checking a defective image caused by the image forming device. First, reference data is converted in accordance with an input format of the image forming device targeted for checking, and an image is outputted by an image forming device targeted for checking (step ST011). Next, an output image sample is read by an image reading section 61, and the read sample is stored in an image data holding section 62 (step ST012). The subsequent processing is carried out in the same manner as that in image reader device check.

Lastly, a technique for checking a defective image caused by a copying device will be described. As described previously, the reference data corresponding to a reference chart is inputted in advance from the image data input/output section 67 to the image data holding section 62. Also, the reference chart characteristic list 73 is stored in advance in the chart characteristic holding section 64.

FIG. 5C is a flow chart showing a method of checking a defective image caused by the copying device. That is, a reference chart is copied by the copying device targeted for checking (step ST021), the copied image sample is read by an image reading section 60, and image read data is stored in the image data holding section 62 (step ST022). The subsequent processing is carried out in the same manner as that in image reader device check.

If the copying device targeted for checking can provides image read data from a scanner section to the outside, and a printer section can input image data from the outside, an image checking process is carried out separately for the scanner section and printer section, as shown in FIGS. 5 and 5B, and a phenomenon name for a respective one of these sections can be specified.

Now, recheck based on the check result will be described.

There is a case in which a phenomenon name cannot be specified completely by one check. For example, in the case of a sub-scanning bright stripe copy caused by fine dust adhered to an exposure laser unit, although a bright stripe appears in a unique pattern with its bright density, such a bright stripe can be filled in a plain dark pattern with very high density, and a defect cannot be detected. Namely, in the chart of FIG. 2, the above phenomenon appears only at a mesh 77 in a unique pattern with low density, and this phenomenon can not be appeared with the mesh 71 or 69. Also, there exists a mesh in which it is impossible to judge whether or not image characteristic quantities appear continuously in a sub-scanning direction. A reference chart of an optimal pattern is automatically selected according to the image characteristic quantities obtained from the previous check result, and an instruction is given to an operator.

FIG. 8 shows an example of a chart instruction table. A chart instruction table 76 describes the image characteristic quantity obtained as described above and the ID and chart name of a chart optimal to specify a possible phenomenon name from the characteristic quantity correspondingly. For example, checks are made by using the reference chart 68, even when the check result is judged to be “normal” because of a set of the obtained characteristic quantities which are insufficient (for example, when two of the characteristic quantities corresponding to the phenomenon name “sub-scanning bright stripe copy” are sampled from the correlation table of FIG. 7), if a sub-scanning bright stripe copy potentially occurs, a “brightening”, “sub-scanning” and “stripe” is sampled in meshes of unique patterns with uniform low density.

In such a case, in the present embodiment, the chart instruction table 76 is referred to based on the obtained characteristic quantities, and an instruction for an optimal chart is given to an operator. For example, even when the check result is judged to be “normal”, when a “brightening” or “sub-scanning” is sampled as a characteristic quantity in any mesh, a chart ID “003” is given to the operator. A subs-canning bright stripe copy can be reliably detected by using the reference chart of the chart ID “003”.

Software according to the embodiment described above can be installed in a notebook type personal computer (PC) or the like hand held by a service man. The software is easily updated because the PC is not set up at a customer's site and is portable by service personnel. Also, a commercially available PC can be used, no problem occurs in CPU performance and main memory size, and there is no need to install the software in the customer's PC.

Now, a checking process using an arbitrary image sample will be described.

FIG. 9 is a flow chart showing this checking process. First, the image analyzing section 63 is initiated in an image sample analysis mode, and an arbitrary image sample is read by the image reading section 60 (step ST031). The image read data is stored as new reference data in the image data holding section 62 together with a new chart ID that is not registered in the reference chart characteristic list 73 yet (step ST032).

In the image data holding section 62, for example, a variety of patterns and their pattern numbers suitable to sample a variety of characteristic quantities as shown in FIG. 4 are stored as a pattern table. The image analyzing section 63 recognizes a pattern configuring the above new reference data, analyzes the configuration pattern and characteristics, and judges a correlation between such each pattern and the pattern in the above pattern table (step ST033). Further, the image analyzing section 63 determines the contents of items such as number of meshes, mesh size, resolution, and configuration pattern, as shown in FIG. 3, for new reference data and adds the determined contents to the reference chart characteristic list 73 together with a new chart ID (step ST034). The subsequent processing is identical to that shown in FIG. 5.

Analysis of the configuration pattern is not always successful in all of the image samples, and all of the image samples cannot always be divided into clean meshes. Thus, only a useful region that has been successfully analyzed is used as a mesh. Thus, a number representing that the chart is specific chart in which meshes are arbitrarily patterned, is assigned as a chart type.

In this way, an image checking process can be carried out by using an arbitrary image sample, thus making it unnecessary for the service man to manage a chart and making it possible for user to carry out maintenance or remote maintenance.

Now, a description will be given with reference to a system for carrying out the above described image checking process, estimating the cause of a defect from the specified phenomenon name, and providing the estimation result. First, a description will be given with reference to a copying machine that carried out the image checking process.

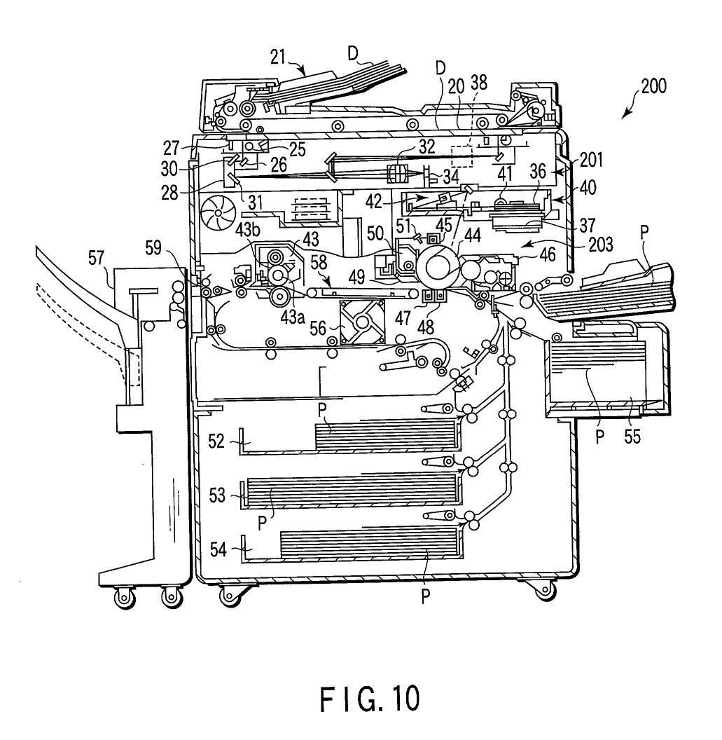

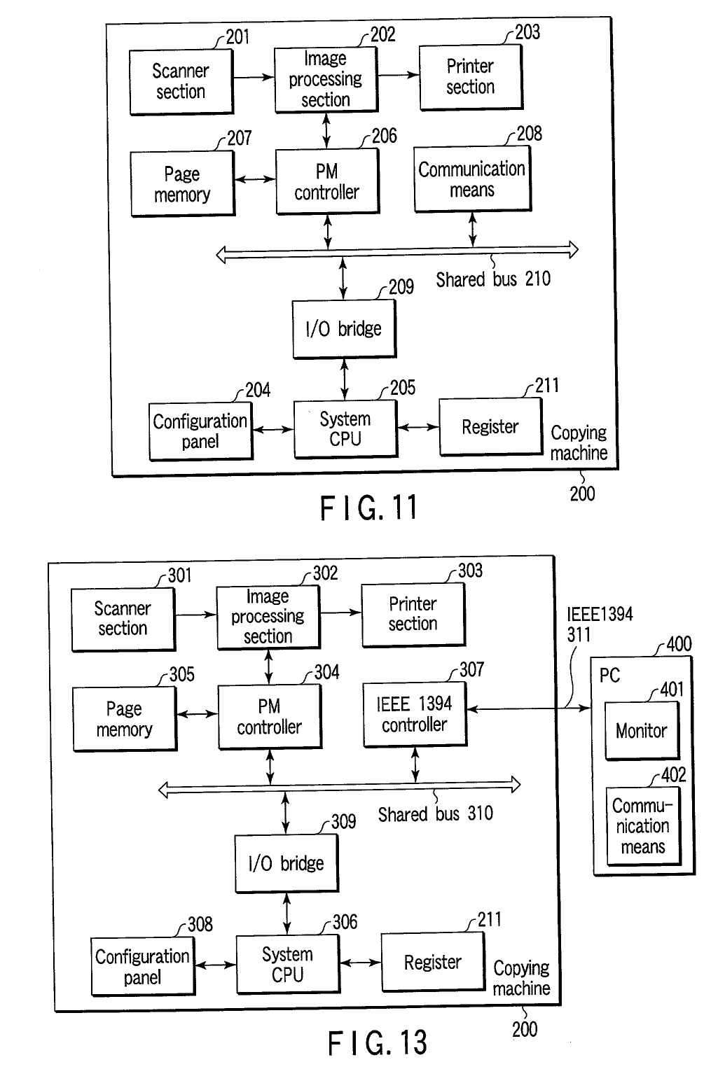

FIG. 10 is a sectional view showing an internal structure of a digital copying machine 200 to which the present invention is applied. In the digital copying machine 200, there are provided a scanner section 201 that functions as a reading section described later and a printer section 203 that functions as an image forming section.

On the top face of the digital copying machine 200, there is provided a document base 20 that consists of a transparent glass on which a reading target, namely, a document D is placed. Also, on the top face of the digital copying machine 200, there is arranged an automatic document feeder device (ADF) 21 that automatically feeds the document D onto the document base 20. This ADF 21 is openably arranged relevant to the document base 20, and functions as a document stop that brings the document D placed on the document base 20 into intimate contact with the document base 20.

The scanner section 201 arranged in the digital copying machine 200 has: an exposure lamp 25 serving as a light source that illuminate the document D placed on the document base 20; and a first mirror 26 that deflects the reflection light from the document D in a predetermined direction. These exposure lamp 25 and first mirror 26 are mounted on a first carriage 27 arranged downwardly of the document base 20.

The first carriage 27 is disposed movably in parallel to the document base 20, and is reciprocally moved downwardly of the document base 20 by a driving motor 38 via meshed belt or the like (not shown).

Further, a second carriage 28 that is movable in parallel to the document base 20 is arranged downwardly of the document base 20. On the second carriage 28, second and third mirrors 30 and 31 that sequentially deflect the reflection lights from the document D deflected by the first mirror 26 are mounted mutually vertically. The second carriage 28 is followed relevant to the first carriage 27 by a meshed belt or the like that drives the first carriage 27, and is moved in parallel to the first carriage along the document base 20 at a velocity of ½.

Downwardly of the document base 20, there are arranged: a focusing lens 32 that focuses the reflection light from a third mirror 31 on the second carriage 28; and a CCD sensor 34 that receives the reflection light focused by the focusing lens 32 and converts the focused light in a photoelectric manner.

On the other hand, the printer section 203 comprises a laser exposure device 40 that acts as an exposure scanner device. The laser exposure device 40 comprises: a semiconductor laser 41 serving as a light source; a polygon mirror 36 serving as a scanning member that continuously deflects laser lights emitted from the semiconductor laser 41; a polygon motor 37 serving as a scanning motor that rotatably drives the polygon mirror 36 in predetermined number of rotations; and a laser optical system 42 that deflects the laser light from the polygon mirror 36, and guides the deflected light to a photosensitive drum 44.

The semiconductor laser 41 is controlled to be turned ON/OFF according to image information or the like of the document D read by the scanner section 201. In the laser exposure device 40, the laser light is oriented to the photosensitive drum 44 via the polygon mirror 36 and laser optical system 42, and the peripheral face of the photosensitive drum 44 is scanned, whereby an electrostatic latent image is formed on the peripheral face of the photosensitive drum 44.

At the periphery of the photosensitive drum 44, there are sequentially disposed: an electrification charger 45 that electrifies the peripheral face of the photosensitive drum 44 at a predetermined potential before an image is formed; a developer 46 that supplies a toner serving as a developing agent to a hidden electrostatic image formed on the peripheral face of the photosensitive drum 44, thereby developing an image as a developing section at a desired image density; a release charger 47 for releasing an image forming medium, namely, copy paper P fed from a paper cassette described later from the photosensitive drum 44; a transfer charger 48 that transfers the toner image formed at the photosensitive drum 44 to the paper P; a release claw 49 that releases the copy paper P from the peripheral face of the photosensitive drum 44; a cleaner device 50 that cleans the residual toner on the peripheral face of the photosensitive drum 44; and a static eliminator 51 that statically eliminates the peripheral face of the photosensitive drum 44. The above photosensitive drum 44 and a developing roller (not shown) or the like in the developer 46 are rotatably driven by a main motor 77.

At the lower part in the digital copying machine 200, there are arranged in a laminate state: an upper cassette 52, a middle cassette 53, and a lower cassette 54 capable of being drawn from a device main body, respectively, and a large capacity feeder 55 is provided laterally. Copy papers P with their difference sizes or orientations are mounted in each of these cassettes. In the digital copying machine 200, there is formed a carrying passage 58 extending through a transfer section positioned between the photosensitive drum 44 and a transfer charger 58 from such each cassette and the large capacity feeder 55. At a terminal end of the carrying passage 58, there is provided; a fixation device 43 having a fixation lamp 43 and a heat roller 43b in which heat is assigned by this fixation lamp 43a. An exit 59 is formed on the side wall of the digital copying machine 200 opposed to the fixation device 43, and a single tray finisher 57 is mounted on an exit 59.

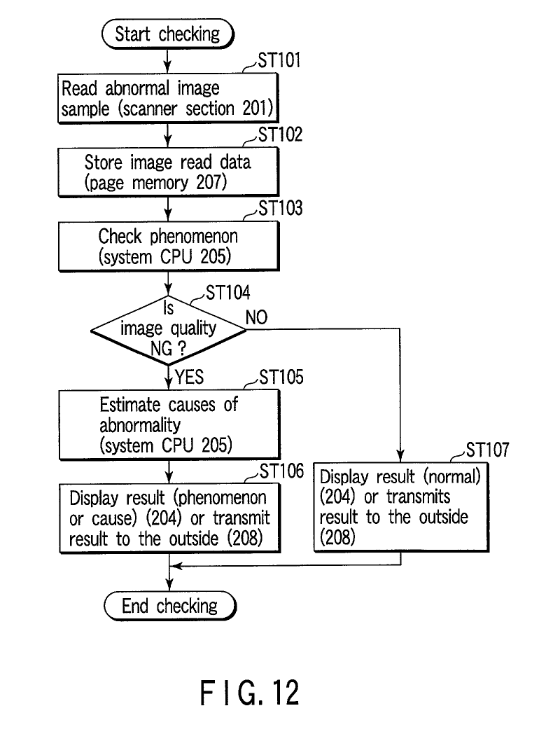

FIG. 11 is a block diagram schematically depicting a configuration of a control system in the digital copying machine 200 to which the present invention is applied. FIG. 12 is a flow chart showing an operation of the present embodiment.

The image data read by the scanner 201 is inputted to an image processing section 202, and the inputted data is stored in a page memory (PM) 207 via a page memory controller (PM controller) 206. A system CPU 205 is accessible to the PM 207 via the PM controller 206.

In an image check mode, when an operation of the copying machine 200 is started, as shown in FIG. 12, a defective image placed on the document base of the scanner 201 is read, and image data is stored in the PM 207 (steps ST101 and ST102). In this case, the defective image indicates an image recognized to be defective by a user due to an unnecessary dot on an image or dirt caused by a toner and the like or an image in which a defect does not occur evidently, the image being merely read for diagnosis. The defective image is a image sample obtained by copying , for example, the reference chart as shown in FIG. 2 by use of the copying machine 200.

The system CPU 205 samples a characteristic quantity in accordance with the above described image analyzing method, and, if a phenomenon (phenomenon name) is specified, stores the phenomenon in a memory (step ST103). When the phenomenon is thus specified, the system CPU 205 judges the read image as a defective image (step ST104).

After a the defective image is judged, the system CPU 205 estimates the cause of a defect from internal parameters such as the values of a life counter stored in a register 211 (such as a use time of the copying apparatus 200 or a total time of rotation operation of the photosensitive drum 44) or error log (past error history) and the above specified phenomenon (step ST105), displays the check result on a configuration panel 204, or transmits the result to the outside via communication section 208 (step ST106). An operator carries out maintenance work based on the check result.

According to the present embodiment, investigation of the causes of a defect is carried out. The operator can identify where the defect occurs instead of whether or not a problem occurs in an image, thus facilitating work. Also, according to the present embodiment, an operation is closed in the copying machine, making it unnecessary to add a device for the purpose of checking.

Now, a description will be given with respect to an image checking system for making checks by using a personal computer (PC) connected via an external interface.

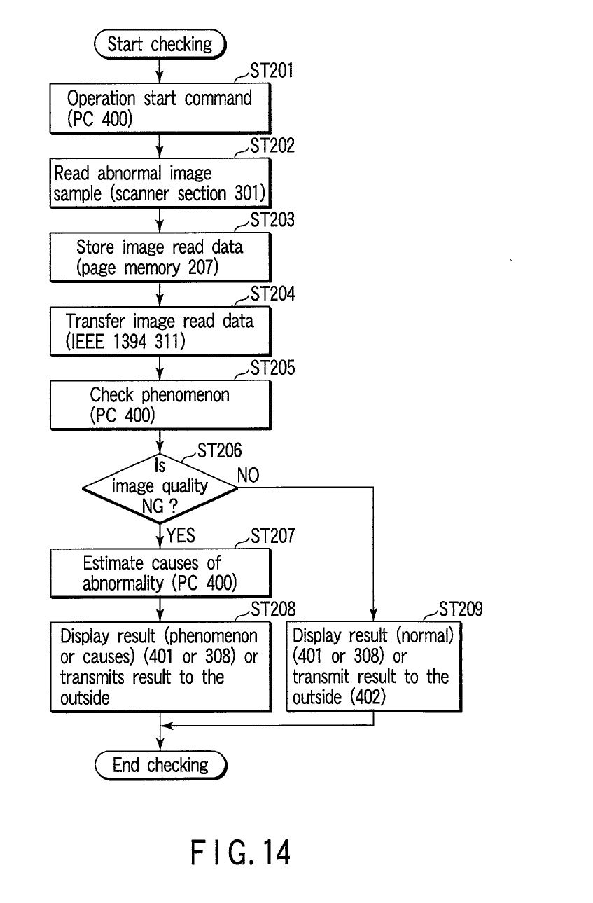

FIG. 13 is a block diagram schematically depicting a configuration of an image checking system according to the present embodiment. FIG. 14 is a flow chart showing an operation of the present embodiment.

The image data read by a scanner 301 is inputted to an image processing section 302, and the inputted data is stored in a PM 305 via PM controller 304. The image data can be transferred to an external PC 400 through an interface with its high transfer rate (of 50 Mbytes/S, for example) such as an IEEE 1394 controller 307, for example.

After an image checking program installed in the PC 400 has been initiated, communication with a copying machine 300 is started, a control panel 308 makes a display so that an image targeted for checking is placed on a document base, and an operation of the scanner section is started (step ST201). An operator places a defective image on a document base, presses a button for executing scanning or enter an execution command from an image quality check program of the PC 400, thereby transferring image data to the PC 400 via the IEEE 1394 controller 307 (steps ST203 and ST204).

When image data is transferred, the image quality check program installed in the PC 400 samples a character quantity in accordance with the above described image analyzing method, and, if a phenomenon (phenomenon name) is specified, stores the phenomenon in a memory (step ST205). If the phenomenon is thus specified, the PC 400 judges the read image as a defective image (step ST206).

After a defective image is judged, the PC 400 estimates the cause of a defect from an ID of an image output device targeted for checking, the ID being inputted in advance, and the above specified phenomenon (step ST207), displays the check result on a monitor 401 or a configuration panel 308 of the copying machine 300, or transmits the result to the outside via communication section 402 (step ST208). The operator carries out maintenance work based on the check result.

Now, a description will be given with respect to an image check system that carries out checks in a network controller connected via network. The network controller has CPU performance equivalent to a commercially available PC and has a size equal to a main memory. Thus, a checking processing according to the present invention can be easily achieved.

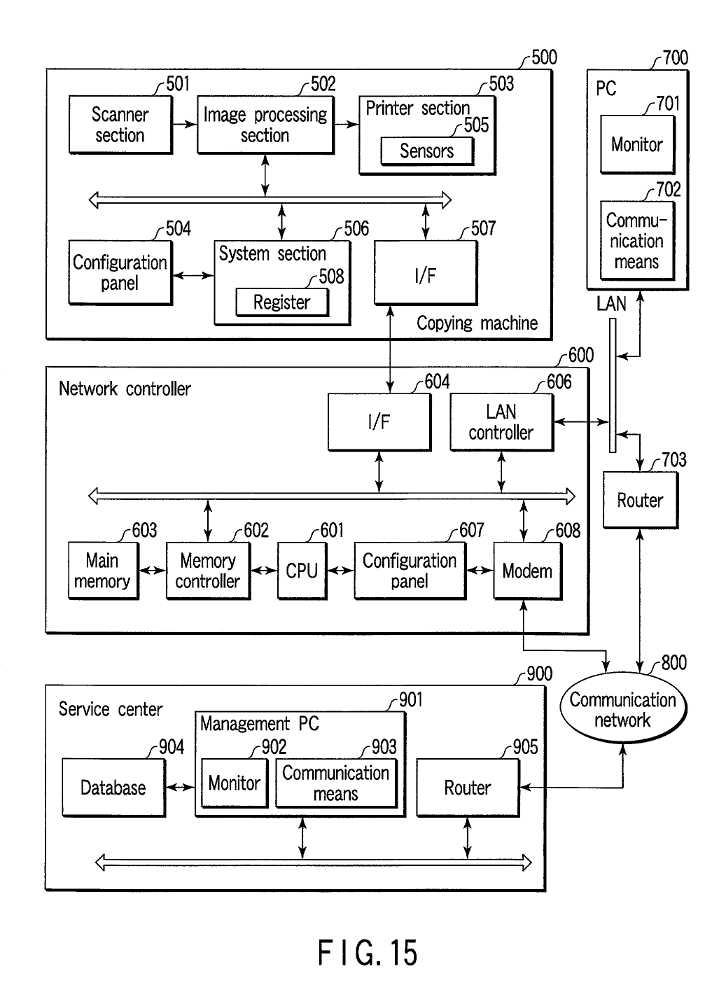

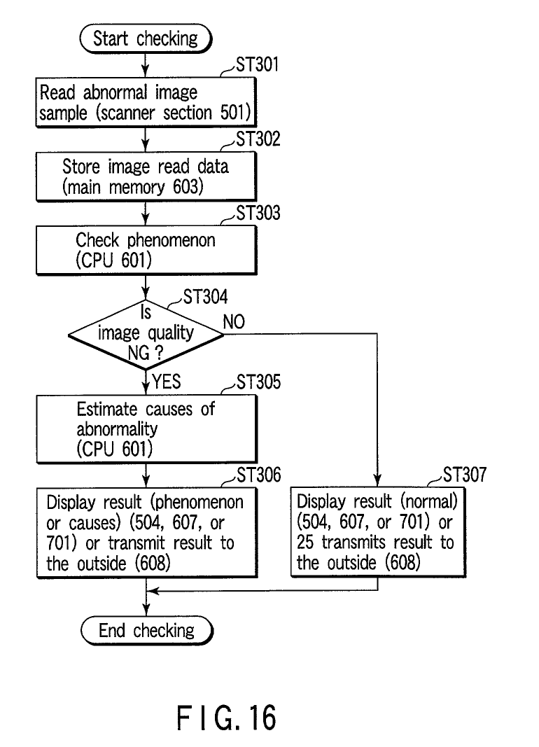

FIG. 15 is a block diagram schematically depicting a configuration of an image checking system according to the present embodiment. FIG. 16 is a flow chart showing an operation of the present embodiment.

A copying machine 500 is connected to a network controller 600, and image data can be inputted and outputted. In an image check mode, when an operation of the copying machine 500 is started, a defective image placed on the document base of a scanner 501 is read, and image data is stored in a main memory 603 in the network controller 600 (steps ST301 and ST302).

The system CPU 601 samples a characteristic quantity in accordance with the above described image analyzing method, and, if a phenomenon (phenomenon name) is specified, stores the phenomenon in a memory (step ST303). After the phenomenon is thus specified, the system CPU 205 judges the read image as a defective image (step ST304).

After the defective image is judged, the CPU 601 estimates the cause of a defect from output values of sensors 505 such as a temperature/humidity sensor mounted on the printer 503 or drum surface potential sensor and the above specified phenomenon (step ST305). Then, the CPU displays the check result on a configuration panel 607 or a configuration panel 504 of the copying machine 500. Alternatively, the CPU transmits the result to the outside via communication section 608 or displays the result on a monitor 701 of a PC 700 connected to a LAN via LAN controller 606 (step ST306). An operator carries out maintenance work based on the check result.

Now, an image checking system that makes checks by using a PC connected via LAN will be described.

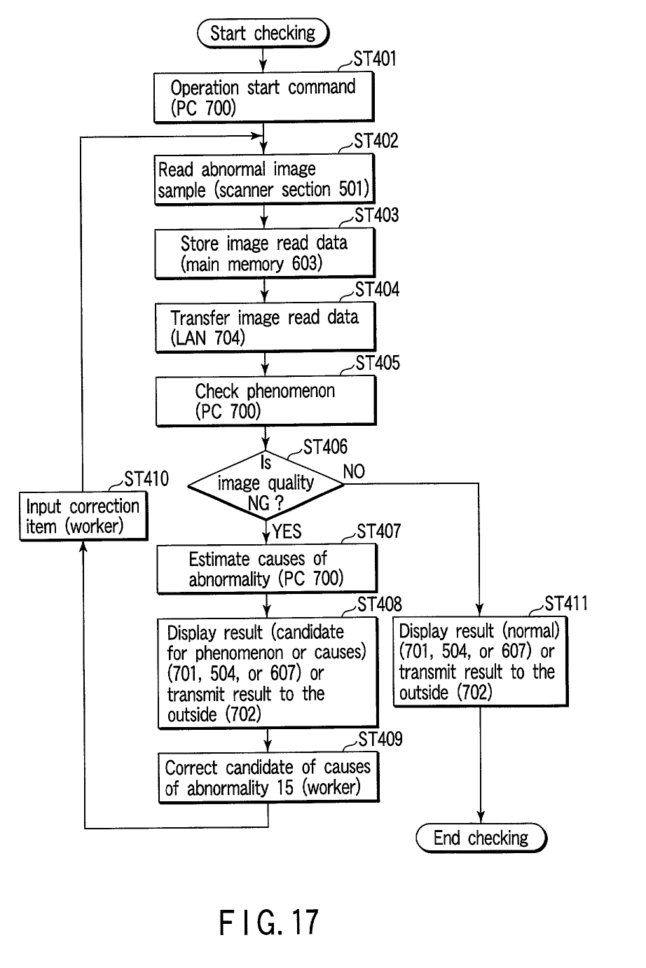

FIG. 15 is a block diagram schematically depicting a configuration of an image checking system according to the present embodiment. FIG. 17 is a flow chart showing an operation of the present embodiment.

The copying machine 500 is connected to the network controller 600, and image data can be inputted and outputted. After an image quality check program installed in the PC 700 connected to the LAN has been initiated, when communication with the copying machine 500 is started via the network controller 600, a control panel 504 makes a display so that an image targeted for checking is placed on a document base, and an operation of a scanner section is started (step ST401). An operator places a defective image on the document base, presses a button for executing scanning of the scanner 501 or inputs an execution command from an image quality check program of the PC 700, thereby transferring the image data to the PC 700 via the network controller 600 (step ST403 and ST404).

When the image data is transferred, the image quality check program installed in the PC 700 samples a characteristic quantity in accordance with the above described image analyzing method, and, if a phenomenon is specified, stores the phenomenon in a memory (step ST405). When the phenomenon is thus specified, the PC 700 judges the read image as a defective image (step ST406).

After the defective image is judged, the PC 700 estimates the cause of a defect from the internal parameters stored in a register 508 in a system section 506 of the copying machine 500 and the above described phenomenon (step ST407). Then, the PC displays the check result on a monitor 701, a configuration panel 504, or a configuration panel 607 or transmits the result to the outside via communication section 706 (step ST408). An operator carries out maintenance work based on the check result.

When a plurality of candidates for the causes of a defect exist in the step ST407, and such defect cannot be recovered by one work, the operator assigns a mark to an actually worked item of the work items in a work list of a check program displayed on the configuration panel 504, and executes a checking scan again (step ST410). The check program excludes the causes of a defect associated with the marked work item from a candidate for the causes of a defect, displays the new check result, and transmits the result. The operator carries out work in accordance with the new check result. This procedure is repeated until the cause of a defect has been clarified.

Now, a description will be given with respect to an image checking system for making checks by using a network controller connected to a network, and estimating the causes of an error at a service center.

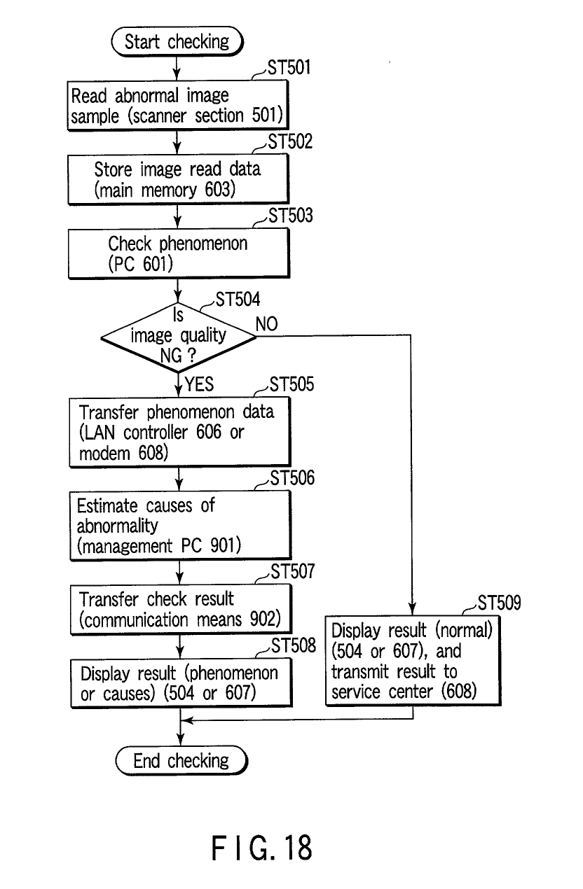

FIG. 15 is a block diagram schematically representing a configuration of an image checking system according to the present embodiment. FIG. 18 is a flow chart showing an operation of the present embodiment.

The copying machine 500 is connected to the network controller 600, and image data can be inputted and outputted. In an image check mode, when an operation of the copying machine 500 is started, a defective image placed on the document base of the scanner 501 is read, and image data is stored in a main memory 603 in the network controller 600 (steps ST501 and ST502).

The CPU 601 samples a characteristic quantity in accordance with the above described image analyzing method, and, if a phenomenon is specified, stores the phenomenon in a memory (step ST503). When the phenomenon is thus specified, the CPU 601 judges the read image as a defective image (step ST504).

After a defective image is judged, phenomenon data passes through a communication network 800 via modem 608 or from a LAN controller 606 via router 703, and is transmitted to a management PC 901 of a remote service center 900 (step ST505).

The management PC 901 having received the phenomenon data acquires associated data from the past check history of the copying machine or a data base 904 having stored therein a frequency of causes of a defect with the same model, and executes a program that estimates the causes of a defect from the above specified phenomenon and the associated data (step ST506). Then, the PC displays the check result on a configuration panel 504, a configuration panel 607, or a monitor 701 via communication network 800 (step ST508). An operator carries out maintenance work based on the check result. When the causes of a defect are thus estimated, check rules depending on environment or life and the like or information on problems with the same model and the like are flexibly assigned as an input.

1. An image analyzing device comprising:
storage section which stores image data obtained by processing reference chart data including a plurality of patterns for sampling each of characteristic quantities indicating characteristics of a defective image, by using a device targeted for checking;
a characteristic quantity sampling section which samples a characteristic quantity of each of the plurality of patterns expressed in the image data stored in the storage section;
a correlation table which associates each label for classifying defective image with at least one of the characteristic quantities corresponding to the label; and
a label specifying section which specifies the label for a pattern in which the characteristic quantity is sampled by the characteristic quantity sampling section from among the plurality of patterns expressed in the image data by referring to the correlation table.

2. An image analyzing device according to claim 1, wherein the reference chart data is a print image, and the image data is electronic data obtained by reading the print image by an image scanner targeted for checking.

3. An image analyzing device according to claim 1, wherein the reference chart data is electronic data, and the image data is electronic data obtained by further reading an image printed by a printer targeted for checking by using the electronic data, by an image scanner.

4. An image analyzing device according to claim 1, wherein the characteristic quantity sampling section applies mutually different processing to the mutually different patterns in order to sample mutually different characteristic quantities.

5. An image analyzing device according to claim 1, wherein, with respect to the reference chart data, a plurality of known image patterns are disposed in a mesh manner, and the characteristic quantity sampling section uses processing suitable to sample characteristic quantities for each mesh.

6. An image analyzing device according to claim 1, further comprising:
a list storage section which stores a reference chart characteristic list having recorded therein characteristics including respective pattern configurations of mutually different reference chart data; and
a selecting section which selects optimal reference chart data from the list storage section according to the characteristic quantity sampled by the characteristic quantity sampling section.

7. An image analyzing device according to claim 1, wherein the image analyzing device is provided in a personal computer.

8. An image analyzing device according to claim 1, further comprising:
an image scanner which reads a document image and provides image data corresponding to the document image, wherein the storage section stores read data obtained by reading an arbitrary sample using an image scanner;
a list storage section which stores a reference chart characteristic list having recorded therein characteristics including respective pattern configurations of mutually different reference chart data;
pattern analyzing section which analyzes characteristics including a pattern configuration of the read data stored by the storage section and adds characteristics including the analyzed pattern configuration to the reference chart characteristic list; and wherein
the arbitrary image sample and the read data are used as new reference chart data.

9. An image checking system comprising:
image analyzing section which analyzes the presence or absence of a defective image from image data obtained by making an electronic data of printed image outputted from a device targeted for checking, and makes classification for each phenomenon which appears on the defective image;
a cause estimating section which narrows a candidate of causes of a defect according to the phenomenon analyzed by the image analyzing section and other information; and
a display section which displays the phenomenon classified by the image analyzing section and the causes of the defect estimated by the cause estimating section.

10. An image checking system according to claim 9, wherein the image analyzing section comprises:
storage section for storing image data obtained by processing reference chart data including a plurality of patterns for sampling each of characteristic quantities indicating characteristics of a defective image, by using a device targeted for checking;
a characteristic quantity sampling section which samples a characteristic quantity of each of the plurality of patterns expressed in the image data stored in the storage section;
a correlation table which associates each label for classifying defective image with at least one of the characteristic quantities corresponding to the label; and
a label specifying section which specifies the label for a pattern in which the characteristic quantity is sampled by the characteristic quantity sampling section from among the plurality of patterns expressed in the image data by referring to the correlation table.

11. An image checking system according to claim 9, wherein the other information is an internal parameter of a device targeted for checking.

12. An image checking system according to claim 9, wherein the other information is an output value of an internal sensor of a device targeted for checking.

13. An image checking system according to claim 9, wherein the other information is input information from a operator.

14. An image checking system according to claim 9, wherein the other information is information on past checking results.

15. An image checking system according to claim 9, further comprising a communication section which transmits to the outside the phenomenon classified by the image analyzing section and the causes of defect estimated by the cause estimating section.

16. An image checking system according to claim 9, further comprising:
a scanner section which reads a document image and provides document image data corresponding to the document image; and
a printer section which forms an image corresponding to the image data provided from the image scanner,
wherein the image data is the document image data provided from the scanner section.

17. An image checking system according to claim 9, further comprising:
a scanner section which reads a document image and provides document image data corresponding to the document image; and
a printer section which forms an image corresponding to the image data provided from the image scanner,
wherein the image data is document image data obtained by further reading the image formed by the printer section based on known reference data produced as electronic data, by use of the scanner section.

18. An image checking system according to claim 9, wherein the image checking system is provided in a personal computer.

19. An image checking system according to claim 9, wherein the image checking system is provided in a network controller connected to the device targeted for checking via network.

20. An image checking system according to claim 9, wherein the image analyzing section is provided in a network controller connected to the device targeted for checking via network, and the cause estimating section is provided in a computer system connected to the network controller via communication network.

21. An image checking system according to claim 9, wherein the image checking system is provided in a personal computer connected to the device targeted for checking via LAN.
